(19) United States
(12) Patent Application Publication
(10) Pub. No.: US 2013/0240786 A1
(43) Pub. Date: Sep. 19, 2013

(54) CERAMIC NON-CUBIC FLUORIDE MATERIAL FOR LASERS

(71) Applicants: Ulrich Weichmann, Eindhoven (DE); Uwe Mackens, Eidhoven (DE); Joachim Opitz, Eindhoven (DE)

(72) Inventors: Ulrich Weichmann, Eindhoven (DE); Uwe Mackens, Eidhoven (DE); Joachim Opitz, Eindhoven (DE)

(73) Assignee: KONINKLIJKE PHILIPS ELECTRONICS N.V., EINDHOVEN (NL)

(21) Appl. No.: 13/989,416

(22) PCT Filed: Nov. 24, 2011
(86) PCT No.: PCT/IB2011/055265

§ 371 Date: May 24, 2013

(30) Foreign Application Priority Data
Dec. 2, 2010 (EP) 10193405.7

(51) Int. Cl. C09K 11/77

(52) U.S. Cl. CPC C09K 11/7773
USPC 252/301.4 H; 264/108

(57) ABSTRACT

The invention relates to a ceramic non-cubic fluoride laser material and methods of its manufacture.

### FIELD OF THE INVENTION

The present invention is directed to laser materials and methods of their preparation

### BACKGROUND OF THE INVENTION

Solid-state light sources are currently entering many different lighting applications and replace the traditional incandescent and gas discharge lamps. For applications with the highest optical demands (e.g. projection, optical fibre applications) lasers are considered the ideal light source. Many applications can already now be served with semiconductor diode lasers, however, when the application requires special wavelengths that are not accessible with semiconductor diodes, usually diode pumped solid-state lasers are to be used to generate the desired laser wavelength.

For many types of these diode pumped solid-state lasers, non-cubic ternary fluoride materials such as LiYF₄ (YLF) are commonly used materials. Prominent examples are blue diode pumped solid-state lasers based on Pr:LiYF₄, that generate the missing green wavelength for projection, Nd:LiYF₄ lasers with emission in the near infrared or Tm,Ho:YLF lasers for applications around 2 μm wavelength.

However, at present these materials are only available as single-crystal materials which have inter alia the drawback that the dotation among the crystal is not uniform.

### SUMMARY OF THE INVENTION

It is an object of the present invention to provide a laser material which is able to at least overcome partially the above-mentioned drawback and which allows for a more uniform distribution of dotation.

This object is solved by a laser material according to claim 1 of the present invention. Accordingly, a ceramic non-cubic fluoridic laser material, especially for use in solid-state lasers is provided.

The term “ceramic material” in the sense of the present invention means and/or includes especially essentially a crystalline or polycrystalline compact material or composite material with a controlled amount of pores or which is pore free.

“Essentially” in the sense of the present invention means and/or includes especially >90 (wt-) %, more preferred >95 (wt-) % and more preferred >98 (wt-) %.

The term “non-cubic” in the sense of the present invention means and/or includes especially a material which elementary cell is not of the cubic type.

The term “fluoridic” in the sense of the present invention means/and or includes especially that—besides inevitable impurities in the range of ≦2 wt-%, preferably ≦1 wt %—all anions in the material are fluorides.

The term “laser material” in the sense of the present invention means and/or includes a material which is the active material in a solid-state laser and therefore shows absorption at the pump wavelength as well as stimulated emission at the laser wavelength.

Surprisingly it has been found that such a laser material has for a wide range of applications within the present invention at least one of the following advantages:
The dotation among the material is more uniform
The degree of freedom in view of the actual shape of the material is higher for ceramic materials than for single-crystals.
In case composite structures are required for certain applications it is usually easier to realize them with ceramic materials rather than single-crystals.

According to a preferred embodiment of the present invention, the ceramic non-cubic fluoridic laser material (hereforth to be called “laser material” for readability purposes) has an oriented crystalline structure.

The term “oriented crystalline structure” especially means and/or includes that the individual crystallites of the ceramic body share essentially the same orientation with respect to a defined axis of the non-cubic crystal structure and/or are oriented along a defined axis of the non-cubic crystal structure.

According to a preferred embodiment the laser material is selected out of the group comprising LiYF₄, LiGdF₄, LiLuF₄, KYF₄, NaYF₄, K₂YF₅, LiKYF₅, LiKGdF₅, LiCaAlF₆, LiSrAlF₆, K₅LaLi₂F₁₀, BaY₂F₃, BaYb₂F₃ and mixtures and/or compositions thereof—such as (but not limited to) Li(Y,Gd)F₄, Li (Y,Lu)F₄ or the like—doped with one or more of the following ions Ce³⁺, Pr³⁺Nd³⁺, Sm³⁺. Eu³⁺. Tb³⁺, Dy³⁺, Ho³⁺, Er³⁺, Yb³⁺, Tm³⁺, U³⁺, Cr³⁺ or mixtures thereof.

It is a further object of the present invention to provide a method for manufacture of a laser material according to the present invention.

This object is solved by a method according to claim 4 of the present invention. Accordingly, a method for manufacture of a ceramic non-cubic fluoridic laser material, especially for use in solid-state lasers is provided comprising an uniaxial hot-pressing step.

Surprisingly it has been found that by using such a method a laser material according to the present invention can made easily and with good material features for a wide range of applications.

The term “hot uniaxial pressing” as used in the context of the present invention is well recognised in the art and to be understood as involving the compaction of powder into a rigid mould by applying pressure in a single axial direction through a rigid die or piston under the application of heat.

Preferably the method comprises a single-axis uniaxial hot-pressing step. This has been found to be advantageous in practice for many applications.

According to a preferred embodiment of the present invention, the hot-pressing step is performed at a temperature in the range of ≧10 and ≦220° C. below the melting temperature of the laser material. This has been shown in practice to be useful since so the best ceramics could be made. Preferably the hot-pressing step is performed at a temperature in the range of ≧15° C. and ≦200° C., more preferred ≧20° C. and ≦100° C. below the melting temperature of the laser material.

According to an embodiment of the present invention, before or during hot-pressing a flux aid is added to the laser material, preferably in a range of ≧0.1 (wt) % and ≦5 wt %, more preferred ≧1 (wt) % and ≦2 wt %. However, this is voluntarily and for many applications it has been found that a flux aid can be omitted. Suitable flux aids are fluoridic materials such as tetrafluoroborates, hexafluorosilicates and hexafluoroaluminates.

The object is furthermore solved by a method according to claim 7 of the present invention. Accordingly, a method for manufacture of a ceramic non-cubic fluoridic laser material, especially for use in solid-state lasers is provided, comprising an extrusion step, whereby the extrusion is performed by pressing the non-cubic fluoridic laser material from a compression room through an orifice.

Surprisingly it has been found that by using such a method a laser material according to the present invention can made easily and with good material features for a wide range of applications. As an additional advantage it has been found that the ceramic material made according to this method usually has an oriented crystalline structure due to the extrusion step. Without being bound to any theory the inventors believe that by using this extrusion-like technique the material undergoes a phase transition from a powder to an oriented ceramic.

According to a preferred embodiment of the present invention the extrusion is performed by pressing the non-cubic fluoridic laser material from a compression room through an orifice, whereby in cross sectional view the area of the orifice is ≧0.5% of the largest diameter of the compression room.

Preferably in cross sectional view the area of the orifice is ≧0.5% and ≦20% of the largest diameter of the compression room, more preferred ≧1% and ≦15% and most preferred ≧2% and ≦10%.

Preferably the extrusion step occurs via or during an uniaxial hot-pressing step. This has been found to be advantageous since by doing so the orifice can be realized by using a device having (at least one) plunger and a die whereby the plunger has a smaller diameter than the inner diameter of the die.

According to a preferred embodiment of the present invention, the extrusion step is performed at a temperature in the range of ≧10 and ≦220° C. below the melting temperature of the laser material. This has been shown in practice to be useful since so the best ceramics could be made. Preferably the hot-pressing step is performed at a temperature in the range of ≧15° C. and ≦200° C., more preferred ≧20° C. and ≦100° C. below the melting temperature of the laser material.

According to a preferred embodiment of the present invention, during the extrusion step the flow of the extruded material is adjusted by temperature and pressure to a mass flow rate of ≧0.02 g/h/mm² and ≦20 g/h/mm². By doing so it has been found that the material can be converted to a ceramic easily and effectfully for most applications within the present invention. Preferably the mass flow rate is ≧0.1 g/h/mm² and ≦10 g/h/mm².

According to a preferred embodiment of the present invention, in cross sectional view the area of the orifice is a square, rectangle, circle or any other desired shape to provide extruded non-cubic fluoridic laser material forming square rods, bars, fibers or bodies with any other desired cross sectional shape.

According to an embodiment of the present invention, before or during hot-pressing a flux aid is added to the laser material, preferably in a range of ≧0.1 (wt) % and ≦5 wt %, more preferred ≧1 (wt) % and ≦2 wt %. However, this is voluntarily and for many applications it has been found that a flux aid can be omitted. Suitable flux aids are fluoridic materials such as tetrafluoroborates, hexafluorosilicates and hexafluoroaluminates.

The present invention furthermore relates to a system comprising a laser material according to the present invention and/or laser materials made according to the inventive methods shown above, being used in one or more of the following applications:
Solid-state lasers
digital projection
fibre-optical applications
medical applications of solid-state lasers
heating applications
scintillation applications
x-ray detectors
γ-ray detectors
high-energy particle detectors

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several embodiments and examples of laser materials according to the invention.

FIG. 1 shows a XRD pattern of a laser material of the present invention according to Example I

FIG. 2 shows a XRD pattern of a laser material of the present invention according to Example II.

FIG. 3 shows an electron microscopy picture of the laser material according to Example I

FIG. 4 shows an alternative electron microscopy picture of the laser material according to Example I

FIG. 5 shows an electron microscopy picture of the laser material according to Example II

FIG. 6 shows an alternative electron microscopy picture of the laser material according to Example II

FIG. 7 shows a picture of the laser material according to Example II

FIG. 8 shows a very schematic cross sectional view of a hot-uniaxial pressing device according to an embodiment of the present invention

FIG. 9 shows the device of FIG. 8 after applying pressure

FIG. 10 shows a diagram showing the results of the hot-uniaxial pressing method according to the invention juxtaposed with comparative non-inventive methods

FIG. 11 shows a very schematic cross-sectional view of a plunger in a die for use in the extrusion step method according to the invention.

FIG. 12 shows two juxtaposed diagrams showing the emission of the material of Example II using a polarimeter, whereby the polarimeter was set up in an angle of 50° and 140°.

FIG. 13 shows a “ratio-diagram”, illustrating the ratio of emission at 523 nm vs the emission at 640 nm of the material of Example II.

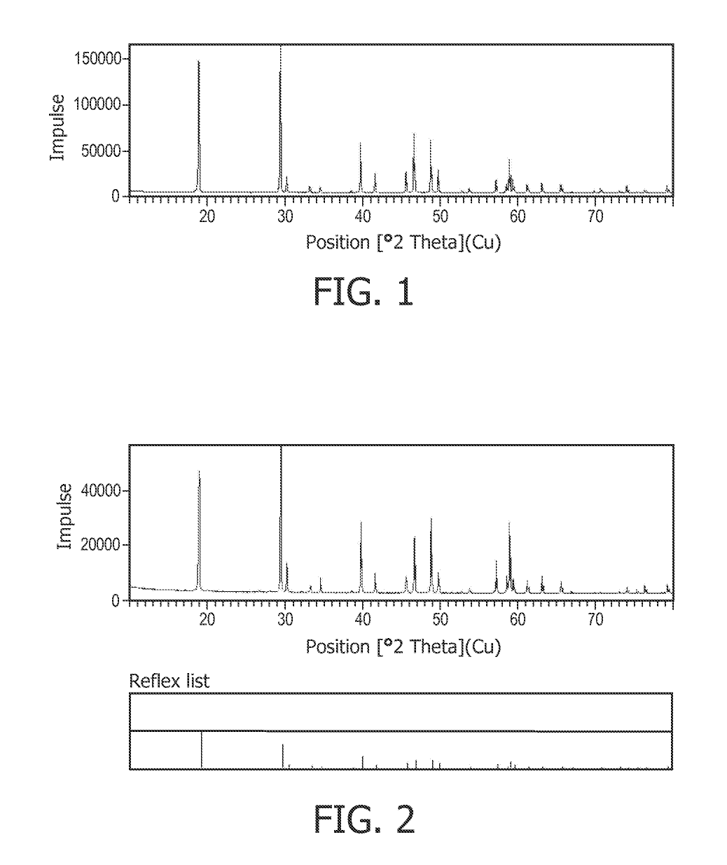

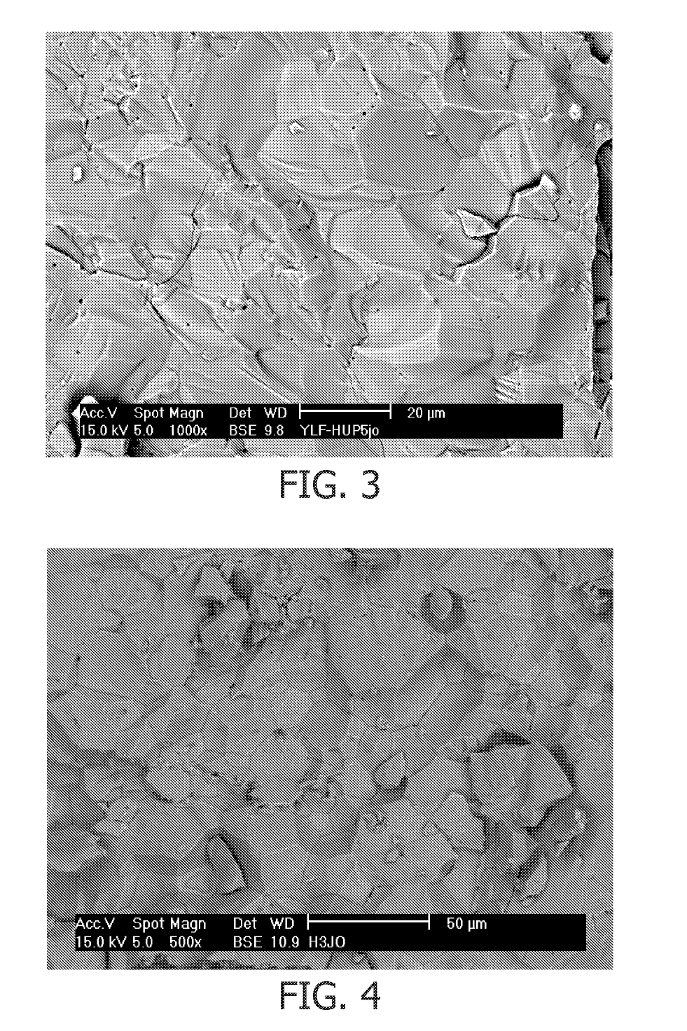

FIG. 1 shows a XRD pattern of a laser material of the present invention according to Example I. This laser material was made using a hot-uniaxial pressing method (as will be shown later on). FIGS. 3 and 4 show electron microscopy pictures of the material.

Both from the XRD pattern as well as from the microscopy pictures it can be clearly seen that the material is phase-pure and comprising to homogeneous dense, polycrystalline compacts with 10-50 μm grain size.

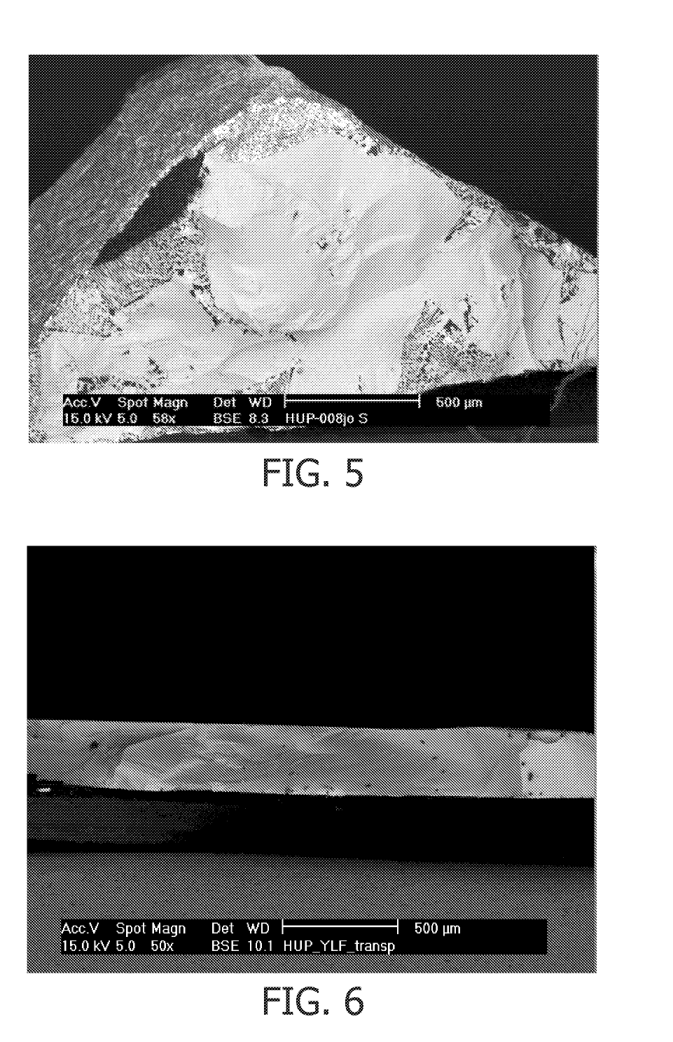

FIG. 2 shows a XRD pattern of a laser material of the present invention according to Example II. This laser material was made using an extrusion step method (as will be shown later on). FIGS. 5 and 6 show electron microscopy pictures of the material.

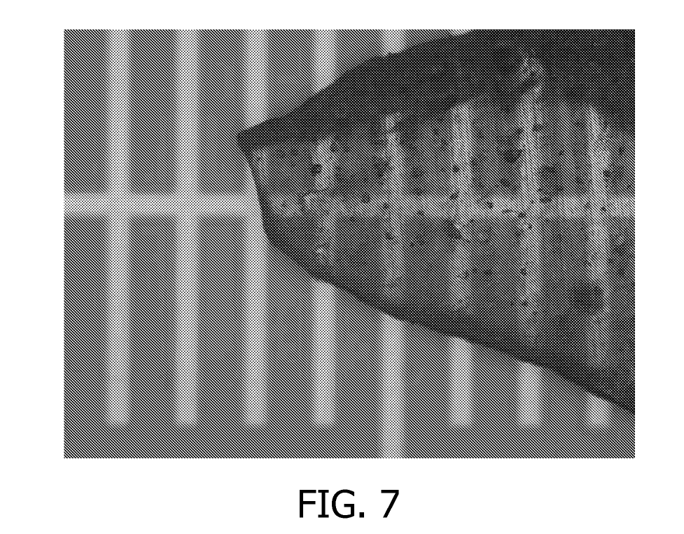

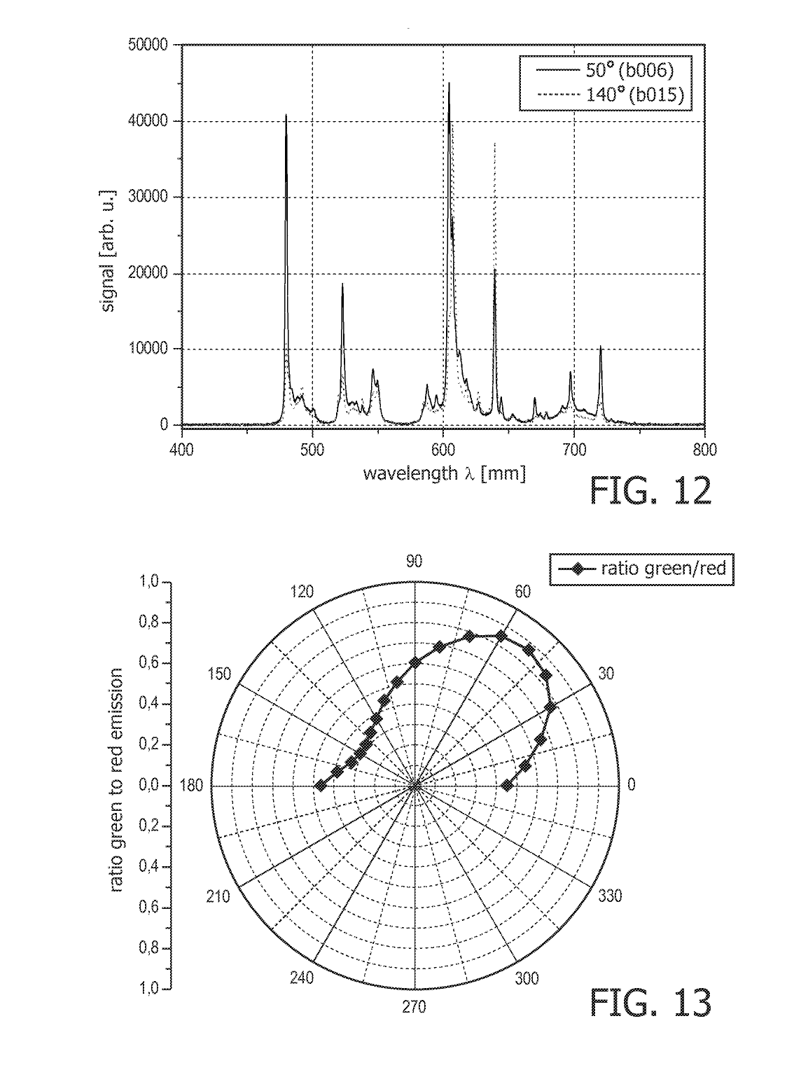

Both from the XRD pattern as well as from the microscopy pictures it can be clearly seen that the material is phase-pure and comprising to homogeneous dense, polycrystalline compacts with a large grain size in (approx.) submillimeter range. A picture of the material can be seen in FIG. 7. From FIGS. 12 to 13 it can be seen that this material has a directed orientation.

### EXPERIMENTAL SECTION

### Example I

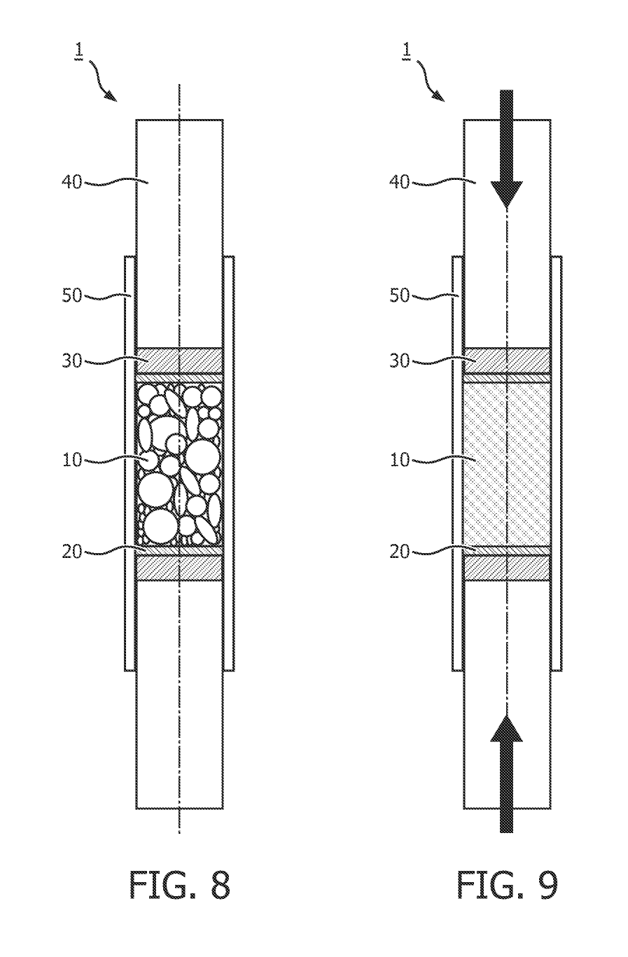

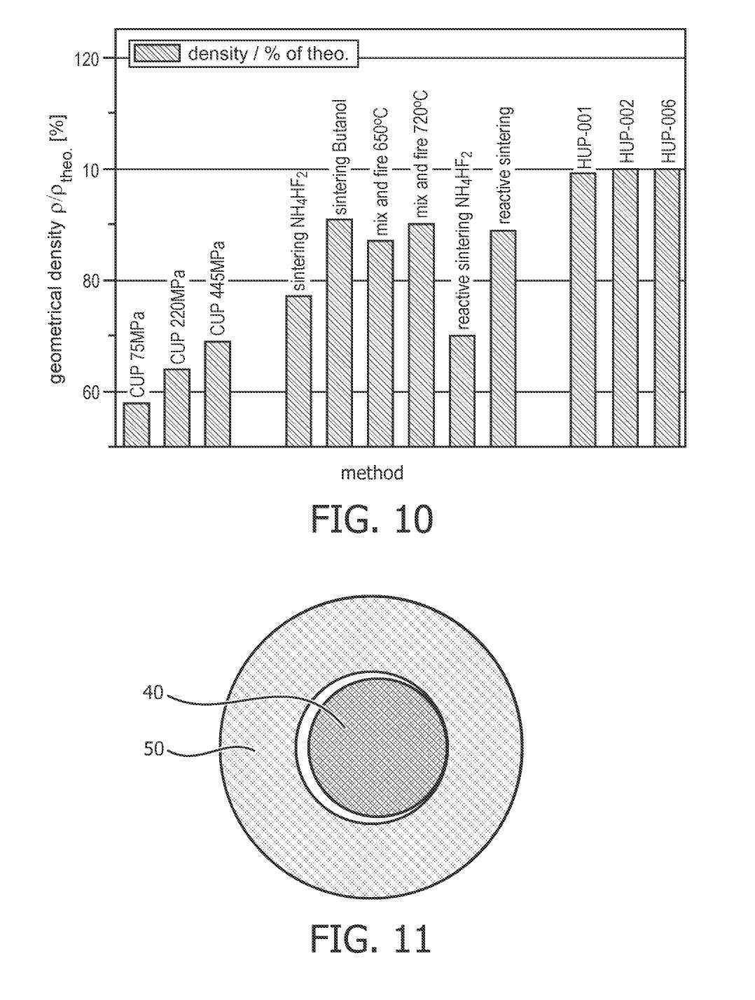

The laser material of Example I was made using a hot-uniaxial pressing step as will be described using the FIGS. 8 and 9.

FIG. 8 shows a very schematic cross sectional view of a hot-uniaxial pressing device 1 according to an embodiment of the present invention. In the device, the material 10 to be converted to a ceramic, in the Example LiYF₄:Pr is provided in powder form in the space between a die 50 and two plungers 40. To prevent side reactions and to ease the manufacturing process, the plungers are equipped with Pt-foils 20 provided towards the material 10 and a further layer of molybdenum 30 between the plunger 40 and the Pt-foil 20.

By applying pressure (indicated by the arrows from either side or from both sides, depending on the application) the material is densified and made to a homogenous ceramic.

The laser material of Example I was made by hot-uniaxial pressing using 65 MPa at 650° C.

Table 10 shows a diagramm showing the results of the hot-uniaxial pressing method (HUP-01, HUP-02, HUP-06) according to the invention juxtaposed with comparative non-inventive methods. The experimental data for the three inventive methods were as follows:

HUP-01: 50 MPa, 650° C., no flux aid

HUP-02: 50 MPa, 650° C., 1% flux aid (LiBF₄)

HUP-06: 50 MPa, 750° C., 1% flux aid (LiBF₄)

As can be seen from Table 10, the geometrical density for the laser materials made in accordance with the inventive method was >95%, whereas comparative methods gave inferior results. Some of the comparative methods are shortly explained below:

CUP 75 MPa: cold isostatic pressing at 75 MPa (CUP X MPa analogue X MPa)

sintering NH₄HF₂: pressureless sintering of the material after CUP-pressing using NH₄HF₂ as sintering aid/binder

sintering Butanol: pressureless sintering of the material after CUP-pressing using butanol as sintering aid/binder

reactive sintering NH₄HF₂:analogue to the above

reactive sintering: analogue to the above, without binder or sintering aid.

### Example II

The laser material according to Example II was made using an extrusion step method. In this method the device of FIG. 8 was altered by using one plunger having a smaller diameter than the die so that an “orifice” was created which had an area of approx. 2% of the area of the die (which forms the “compression room”). A cross sectional view of the plunger 40 inside the die 50 can be seen in FIG. 11. To be precise, the plunger had a diameter of 21.1 mm whereas the inner diameter of the die was 21.4 mm, resulting in an orifice area of approx. 10 mm².

The starting material (LiYF₄:Pr) was heated up to about 750° C. and pressure was applied. At around 17 MPa it could be observed that the LiYF₄:Pr started to be extruded through the orifice. After 5 h approx. 10% of the starting material had left the orifice in ceramic form; an increase of the temperature to 790° C. (i.e. approx. 20° C. below the melting point of 812° C.) and application of more pressure resulted in accelerated extrusion so that after 5 hrs at 24 MPa around 70% of the starting material had left the orifice; the extrusion was then halted.

FIG. 7 shows a picture of the resulting ceramic LiYF₄:Pr; it can be seen that the material is essentially ceramic and of good transparency.

FIG. 12 shows two juxtaposed diagrams showing the emission of the material of Example II using a polarimeter, whereby the polarimeter was set up in an angle of 50° and 140°, FIG. 13 shows a “ratio-diagram”, illustrating the ratio of emission at 523 nm vs the emission at 640 nm of the material of Example II. From both FIG. 12 and FIG. 13 it can clearly be seen that the whole ceramic consists of oriented grains, i.e. that by using the extrusion method as shown in this invention, an oriented material with an oriented crystalline structure can be achieved.

It should be noted that the best results were achieved when the plunger was not centered within the die (like in FIG. 11) although this is not binding and depends on the actual application.

Furthermore it should be noted that when the die had an inner diameter of 21.2 mm (with a plunger having a diameter of 21.1 mm) then no extrusion could be observed; however a ceramic material could be achieved (according to the uniaxial hot-pressing method described above).

As shown above, in some experiments a flux aid (1% LiBF₄) was added, however, it was found that the method is not limited to a flux aid so that depending on the actual application a flux aid may be omitted or added ad lib.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed.

Accordingly, the foregoing description is by way of example only and is not intended as limiting. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. The invention's scope is defined in the following claims and the equivalents thereto. Furthermore, reference signs used in the description and claims do not limit the scope of the invention as claimed.

1. A ceramic non-cubic fluoridic laser material, wherein the material has an oriented crystalline structure such that the individual crystallites of the ceramic body share essentially the same orientation with respect to a defined axis of the non-cubic crystal structure and are oriented along a defined axis of the non-cubic crystal structure.

2. The material of claim 1, wherein the material comprising polycrystalline compacts with a large grain size in a sub-millimeter range.

3. The material of claim 1, wherein the material is selected from the group consisting of LiYF₄, LiGdF₄, LiLuF₄, KYF₄, NaYF₄, K₂YF₅, LiKYF₅, LiKGdF₅, LiCaAlF₆, LiSrAlF₆, K₅LaLi₂F₁₀, BaY₂F₈, BaYb₂F₈ and mixtures and ternary components thereof, doped with one or more of the following ions Ce³⁺, Pr³⁺Nd³⁺, Sm³⁺. Eu³⁺. Tb³⁺, Dy³⁺, Ho³⁺, Er³⁺, Yb³⁺, Tm³⁺, U³⁺, Cr³⁺ or mixtures thereof.

4.-6. (canceled)

7. A method for manufacture of a ceramic non-cubic fluoridic laser material comprising an extrusion step, wherein the extrusion is performed by pressing the non-cubic fluoridic laser material from a compression room through an orifice at a temperature in the range of ≧10 and ≦220° C. below the melting temperature of the non-cubic fluoridic laser material.

8. The method of claim 7, wherein during the extrusion step in cross sectional view the area of the orifice is ≧0.5% of the largest diameter of the compression room.

9. The method of claim 7, the extrusion step occurs via or during an uniaxial hot-pressing step.

10. A system comprising a ceramic non-cubic fluoridic laser material, wherein the material has an oriented crystalline structure such that the individual crystallites of the ceramic body share essentially the same orientation with respect to a defined axis of the non-cubic crystal structure and are oriented along a defined axis of the non-cubic crystal structure, the system being used in one or more of the following applications:
Solid-state lasers
digital projection
fibre-optical applications
medical applications of solid-state lasers
heating applications
scintillation applications
x-ray detectors
γ-ray detectors
high-energy particle detectors

11. The method of claim 7, wherein during the extrusion step the flow of the extruded material is adjusted by temperature and pressure to a mass flow rate of ≧0.02 g/h/mm² and ≦20 g/h/mm².
